(19) United States
(12) Patent Application Publication
(10) Pub. No.: US 2013/0061059 A1
(43) Pub. Date: Mar. 7, 2013

(54) INFORMATION PROCESSING APPARATUS, INFORMATION PROCESSING METHOD, AND NON-TRANSITORY COMPUTER READABLE MEDIUM

(71) Applicant: Kiyoshi TASHIRO, Kanagawa (JP)

(72) Inventor: Kiyoshi TASHIRO, Kanagawa (JP)

(73) Assignee: FUJI XEROX CO., LTD., Tokyo (JP)

(21) Appl. No.: 13/372,083

(22) Filed: Feb. 13, 2012

(30) Foreign Application Priority Data
Sep. 7, 2011 (JP) 2011-194921

(51) Int. Cl. G06F 21/00

(52) U.S. Cl. 713/189

(57) ABSTRACT

An information processing apparatus including a virtual computer includes a key pair generating unit that generates a key pair of a virtual computer secret key and a virtual computer public key, a public key output unit that outputs the virtual-computer public key, a process target data retrieving unit that retrieves process target data encrypted with the virtual computer public key, a decryption unit that decrypts the retrieved process target data, a process program retrieving unit that retrieves a process program, an executing unit that executes the retrieved process program on the decrypted process target data, a public key retrieving unit that retrieves a process requester public key, an encryption unit that encrypts, with the retrieved process requester public key, process result data as a process result of the process program, and a process result data output unit that outputs the encrypted process result data.

### CROSS-REFERENCE TO RELATED APPLICATIONS

This application is based on and claims priority under 35 USC 119 from Japanese Patent Application No. 2011-194921 filed Sep. 7, 2011.

### BACKGROUND

(i) Technical Field

The present invention relates to an information processing apparatus, an information processing method, and a non-transitory computer readable medium.

(ii) Related Art

Techniques to verify authenticity of a process requested side that is requested to process information are available.

### SUMMARY

According to an aspect of the invention, there is provided an information processing apparatus. The information processing apparatus includes a virtual computer. The virtual computer includes a key pair generating unit that generates a key pair of asymmetric cryptography including a virtual computer secret key used in only the virtual computer of the information processing apparatus and a virtual computer public key corresponding to the virtual computer secret key, a public key output unit that outputs the virtual computer public key of the key pair generated by the key pair generating unit, a process target data retrieving unit that retrieves, from outside the virtual computer, process target data encrypted with the virtual computer public key, a decryption unit that decrypts the process target data encrypted with the virtual computer public key and retrieved by the process target data retrieving unit, a process program retrieving unit that retrieves a process program from outside the virtual computer, an executing unit that executes the process program retrieved by the process program retrieving unit on the process target data decrypted by the decryption unit, a public key retrieving unit that retrieves a process requester public key from outside the virtual computer, an encryption unit that encrypts, with the process requester public key retrieved by the public key retrieving unit, process result data provided by the executing unit as a process result of the process program, and a process result data output unit that outputs, to outside the virtual computer, the process result data encrypted by the encryption unit.

### BRIEF DESCRIPTION OF THE DRAWINGS

Exemplary embodiments of the present invention will be described in detail based on the following figures, wherein:

FIG. 1 illustrates a module configuration of an exemplary embodiment;

FIG. 2 illustrates a module configuration of a virtual computer;

FIG. 3 is a flowchart illustrating a process of the exemplary embodiment;

FIG. 4 is a flowchart illustrating a process of the exemplary embodiment;

FIG. 5 illustrates a module configuration of a computer;

FIG. 6 is a flowchart illustrating a process of the exemplary embodiment;

FIG. 7 is a flowchart illustrating a process of the exemplary embodiment; and

FIG. 8 is a block diagram illustrating a hardware configuration of a computer implementing the exemplary embodiment.

### DETAILED DESCRIPTION

One exemplary embodiment of the present invention is described below with reference to the drawings.

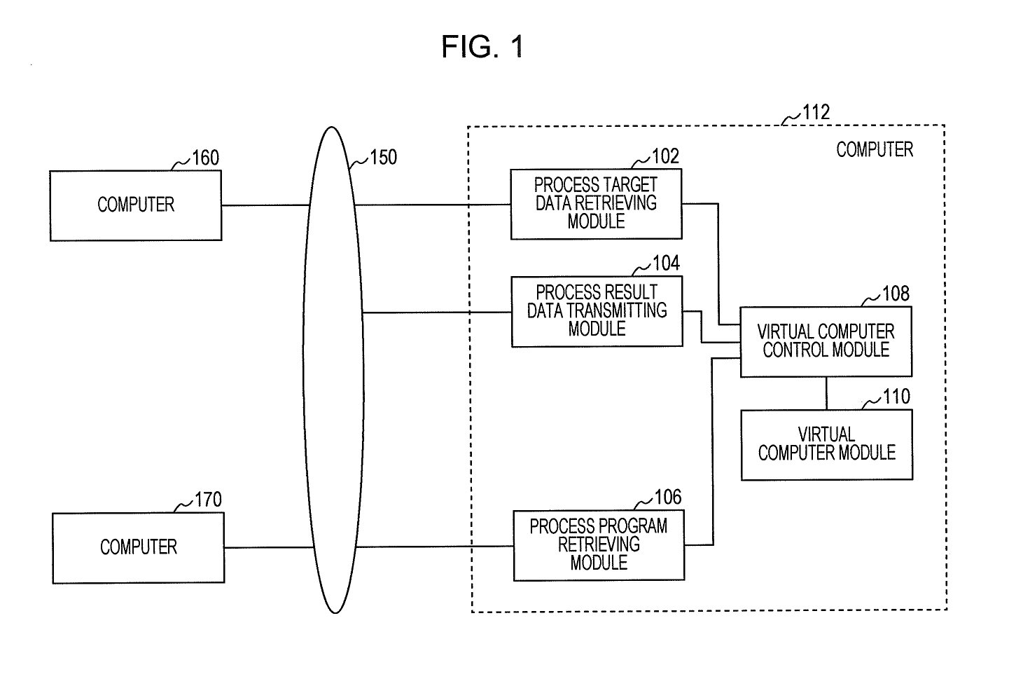

FIG. 1 illustrates a configuration of modules of the exemplary embodiment. The word module refers to a software component that is logically separable (a computer program or simply a program), or a hardware component. The module of the exemplary embodiment refers to not only a module in a computer program but also a module in a hardware structure. The discussion of the exemplary embodiments also serves as the discussion of computer programs for causing the modules to function (including a program that causes a computer to execute each step, a program that causes the computer to function as an element, and a program that causes the computer to implement each function), a system and a method. In the discussion that follows, the phrases “stores information,” “causes information to be stored,” and other phrases equivalent thereto are used. If an exemplary embodiment is a computer program, these phrases are intended to express “causes a memory device to store information” or “controls a memory device to cause the memory device to store information.” The modules may correspond to the functions in a one-to-one correspondence. In a software implementation, one module may be composed of one program or multiple modules may be composed of one program. One module may be composed of multiple programs. Multiple modules may be executed by a single computer. A single module may be executed by multiple computers in a distributed environment or a parallel environment. One module may include another module. In the discussion that follows, a “connection” refers to not only a physical connection but also a logical connection (such as an exchange of data, instructions, and data reference relationship). The word “predetermined” means that something is decided in advance of a process of interest. The word “predetermined” is thus intended to refer to something that is decided in advance of a process of interest in the exemplary embodiment. Even after a process in the exemplary embodiment has started, the word “predetermined” refers to something that is decided in advance of a process of interest depending on a condition or a status of the exemplary embodiment at the present point of time or depending on a condition or status heretofore continuing down to the present point of time.

The word “system” and the word “apparatus” refer to an arrangement where multiple computers, a hardware structure, and an apparatus are interconnected via a communication network (including a one-to-one communication connection). The word “system” and the word “apparatus” also refer to an arrangement that includes a single computer, a hardware structure, and an apparatus. The word “system” and the word “apparatus” have the same definition and are interchangeable with each other. The system in the context of the exemplary embodiment does not include a social system that is a social arrangement formulated by humans.

At each process performed by a module, or at one of the processes performed by a module, information as a process target is read from a memory device, the information is then processed, and the process results are written onto the memory device. A description of the reading of the information from the memory device prior to the process and the writing of the processed information onto the memory device subsequent to the process may be omitted as appropriate. The memory devices may include a hard disc, a random access memory (RAM), an external storage medium, a memory device connected via a communication line, and a register within a central processing unit (CPU).

An information processing apparatus (computer 112) of the exemplary embodiment retrieves process target data that are confidential, and a process program, and executes the process program on the process target data (this series of steps may also referred to as a proxy operation in outsourcing). As illustrated in FIG. 1, the computer 112 is connected to a computer 160 and a computer 170 via a communication line 150. The computer 112, the computer 160, and the computer 170 are computers, each having a physical entity. Each of the computer 112, the computer 160, and the computer 170 may be composed of a single apparatus or a plurality of apparatuses. The communication line 150 may be the Internet.

Paid or free services that process data using the Internet are in widespread use, and are typically referred to as web services. The exemplary embodiment may be applied in the web service.

In the web service, a process requester may transmit, to the web service, data to be processed without preparing a computer and a program for the process, and obtain desired process results by simply receiving data as the process results. The technique called hyper text transfer protocol (HTTP) is used in the exchange of the data in the web service. To protect the data from a third party, the technique called secure socket layer (SSL) is typically used. In one related art, a process using the data (an entity on which an application program is executed on a memory) is identified, and a client issues to a server a data transmission request together with information unique to the process. Based on the information unique to the process, the server having received the request determines whether to transmit confidential data.

The data processing in the web service may be provided in a variety of forms by a large number of providers. A providing entity providing data processing service is herein referred to as a process provider. An entity requesting the data to be processed is referred to a process requester.

In corporate activity, data processing in business is performed in a variety of forms. If the data processing is performed using the web service, a large number of process providers are used.

The computer 160 is connected to a process target data retrieving module 102 and a process result data transmitting module 104 in the computer 112 via the communication line 150. The computer 160 is used by the process requester. The computer 160 requests the computer 112 to perform the proxy operation to process the data, and then transmits the data to the computer 112 (hereinafter referred to as process target data). The computer 160 then receives data as process results (hereinafter referred to as process result data).

The computer 170 is connected to the process program retrieving module 106 in the computer 112 via the communication line 150. The computer 170 provides a process program for the proxy operation. The computer 170 transmits the process program for proxy operation. The computer 170 is used by a provider of the process program (hereinafter referred to as a process provider).

The computer 112 performs the proxy operation. The computer 112 receives a proxy operation request from the computer 160, and the process target data. The computer 112 receives from the computer 170 the process program for processing the process target data (optionally, the computer 112 may receive and store the process program beforehand). The computer 112 executes the process program on the process target data. The owner of the computer 112 may be the process provider or another entity.

The computer 112 includes process target data retrieving module 102, process result data transmitting module 104, process program retrieving module 106, virtual computer control module 108, and virtual computer module 110. Each module may be executed as a program on the computer 112.

The process target data retrieving module 102 is connected to the virtual computer control module 108, and is also connected to the computer 160 via the communication line 150.

The process result data transmitting module 104 is connected to the virtual computer control module 108 and is also connected to the computer 160 via the communication line 150.

The process program retrieving module 106 is connected to the virtual computer control module 108 and is also connected to the computer 170 via the communication line 150.

The programs as the process target data retrieving module 102, the process result data transmitting module 104, and the process program retrieving module 106 may be an HTTP service program. In such a case, the retrieval and the transmission of the data, the process program, and the like may be performed as a request and a response to the request in the HTTP protocol. More specifically, the retrieval of the process target data may be performed when the computer 160 used by the process requester transmits the process target data in accordance with the HTTP protocol, and the computer 112 performing the proxy operation receives the process target data. The retrieval procedure of the process target data is described in detail below. The transmission of the process result data may be performed when the computer 112 performing the proxy operation transmits the process result data in accordance with the HTTP protocol, and the computer 160 used by the process requester receives the process result data. The retrieval of the process program is performed when the computer 170 used by the process provider transmits the process program in accordance with the HTTP protocol and the computer 112 performing the proxy operation receives the process program. Since it is likely that the retrieved process program is repeatedly used, the process program is stored on a storage device in the computer 112 performing the proxy operation.

The virtual computer control module 108 is connected to the process target data retrieving module 102, the process result data transmitting module 104, the process program retrieving module 106, and the virtual computer module 110. The virtual computer control module 108 controls the startup and the deletion of the virtual computer module 110 (the deletion at the end of the process of the virtual computer module 110), and controls the deletion of data used by the virtual computer module 110 at the deletion of the virtual computer module 110. The virtual computer control module 108 also inputs and outputs data, and the process program, and manages status data of the virtual computer module 110. The specific process of the virtual computer control module 108 is described in detail below. The virtual computer is a program emulating an operation of a computer. An emulated virtual computer itself is also referred to as a virtual computer. The virtual computer allows operating systems (OS) of multiple computers to operate on a single computer, and allows a program of a computer as another architecture to operate. In other words, in a computing process, at least one virtual computer operates on a physical computer, and each virtual computer processes data. In the virtual computer, all the statuses in the virtual computer are stored using at least one file. This file group is referred to as status data. The virtual computer may start with the same status by causing the virtual computer to operate on the status data having the same content. All the information stored on the virtual computer may be deleted by deleting the status data.

Throughout from the initialization of the virtual computer module 110 to the deletion of the virtual computer module 110, the virtual computer control module 108 controls the virtual computer module 110 such that the virtual computer module 110 receives only the process target data and process program and outputs only virtual computer public key and process result data. Alternatively, the virtual computer module 110 is designed to receive only the process target data and process program and outputs only the virtual computer public key and process result data.

The virtual computer module 110 is connected to the virtual computer control module 108. The process of modules within the virtual computer module 110 is described below in detail.

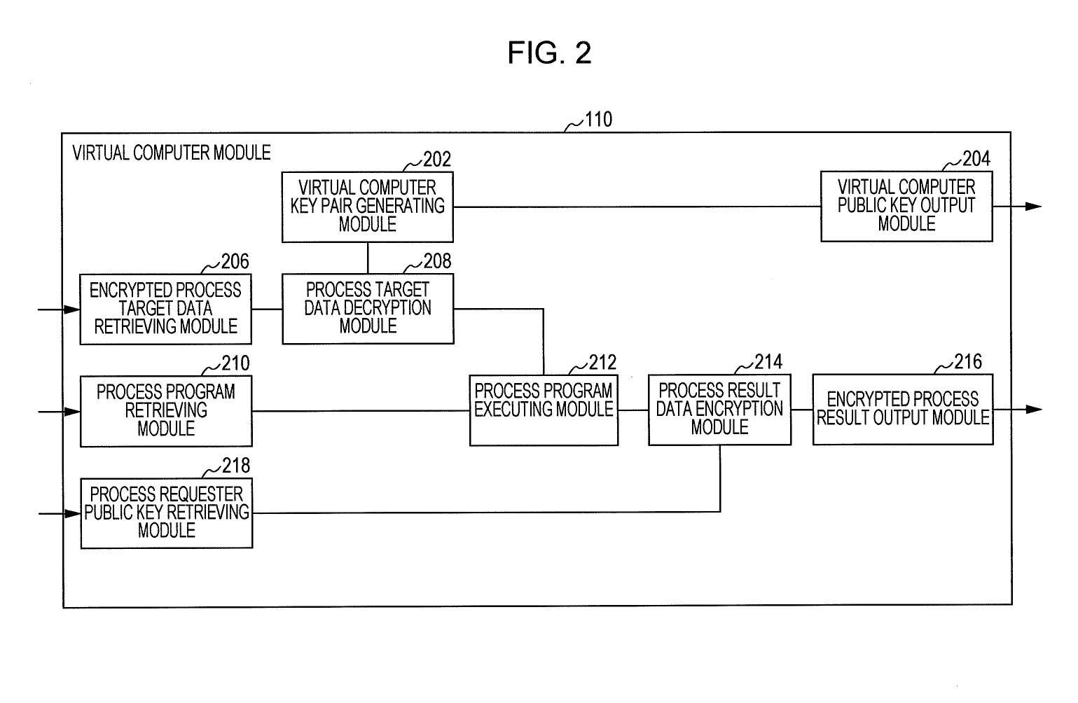

FIG. 2 illustrates a module configuration of the virtual computer module 110.

The virtual computer module 110 includes virtual computer key pair generating module 202, virtual computer public key output module 204, encrypted process target data retrieving module 206, process target data decryption module 208, process program retrieving module 210, process program executing module 212, process result data encryption module 214, encrypted process result data output module 216, and process requester public key retrieving module 218. These modules are implemented as programs executed within the virtual computer module 110. The virtual computer module 110 starts up (is generated) by the virtual computer control module 108. At least one virtual computer module 110 may be employed. If multiple virtual computer modules 110 are employed, the virtual computer modules 110 independently operate in parallel and do not intervene with each other. The inputting of the data used by the virtual computer module 110, the outputting of data by the virtual computer module 110, and the inputting of the process program to be executed by the virtual computer module 110 are controlled only by the virtual computer control module 108. The data used in the virtual computer module 110 is not accessible from outside the virtual computer module 110.

Techniques of protecting data retained by the virtual computer module 110 are in widespread use, and one of the techniques may be used in the exemplary embodiment. For example, in a related art technique, the status data of a status of the virtual computer module 110 is encrypted with a key retained by the virtual computer module 110 (the key may be an asymmetric cryptography key described below or a key for use in another encryption scheme).

The virtual computer key pair generating module 202 is connected to the virtual computer public key output module 204 and the process target data decryption module 208. The virtual computer key pair generating module 202 generates a key pair of a virtual computer secret key used only within the virtual computer module 110 in the computer 112 and a virtual computer public key corresponding to the virtual computer secret key.

The virtual computer public key output module 204 is connected to the virtual computer key pair generating module 202. The virtual computer public key output module 204 outputs the virtual computer public key of the key pair generated by the virtual computer key pair generating module 202.

The process of the virtual computer key pair generating module 202 and the virtual computer public key output module 204 is described below. The virtual computer key pair generating module 202 generates the key pair used in asymmetric cryptography, i.e., a pair of numbers. In the exemplary embodiment, the virtual computer public key output module 204 outputs one of the pair of numbers as a public key to the virtual computer control module 108. The other of the pair of numbers is retained in a secret key storage module (not illustrated) in the virtual computer module 110.

The encrypted process target data retrieving module 206 is connected to the process target data decryption module 208. The encrypted process target data retrieving module 206 retrieves from outside the virtual computer module 110 the process target data encrypted with the virtual computer public key.

The process target data decryption module 208 is connected to the virtual computer key pair generating module 202, the encrypted process target data retrieving module 206, and the process program executing module 212. The process target data decryption module 208 decrypts with the virtual computer secret key the process target data encrypted with the virtual computer public key and retrieved by the encrypted process target data retrieving module 206.

The process of the encrypted process target data retrieving module 206 and the process target data decryption module 208 is described below. The encrypted process target data retrieving module 206 retrieves the process target data from outside the virtual computer module 110, i.e., from the virtual computer control module 108. The retrieved encryption target data are the data encrypted with the virtual computer public key. The process target data decryption module 208 decrypts the process target data with the virtual computer secret key retained in the secret key storage module within the virtual computer module 110.

The process program retrieving module 210 is connected to the process program executing module 212. The process program retrieving module 210 retrieves the process program from outside the virtual computer module 110.

The process program executing module 212 is connected to the process target data decryption module 208, the process program retrieving module 210, and the process result data encryption module 214. The process program executing module 212 executes the process program retrieved by the process program retrieving module 210 on the process target data decrypted by the process target data decryption module 208.

The process of the process program retrieving module 210 and the process program executing module 212 is described below. The process program retrieving module 210 retrieves the process program from outside the virtual computer module 110, i.e., from the virtual computer control module 108. The process program executing module 212 executes the process program on the decrypted process target data and obtains the process result data.

The process requester public key retrieving module 218 is connected to the process result data encryption module 214. The process requester public key retrieving module 218 retrieves a process requester public key from outside the virtual computer module 110.

The process result data encryption module 214 is connected to the process program executing module 212, the encrypted process result data output module 216, and the process requester public key retrieving module 218. The process result data encryption module 214 encrypts the process result data as a process result of the process program executed by the process program executing module 212 with the process requester public key retrieved by the process requester public key retrieving module 218.

The encrypted process result data output module 216 is connected to the process result data encryption module 214. The encrypted process result data output module 216 outputs to the outside the process result data encrypted by the process result data encryption module 214.

The process of the process requester public key retrieving module 218, the process result data encryption module 214, and the encrypted process result data output module 216 is described below. The process requester public key retrieving module 218 retrieves the process requester public key from outside the virtual computer module 110, i.e., from the virtual computer control module 108. The process result data encryption module 214 encrypts the process result data with the process requester public key. The encrypted process result data output module 216 outputs the encrypted process result data to outside the virtual computer module 110, i.e., to the virtual computer control module 108.

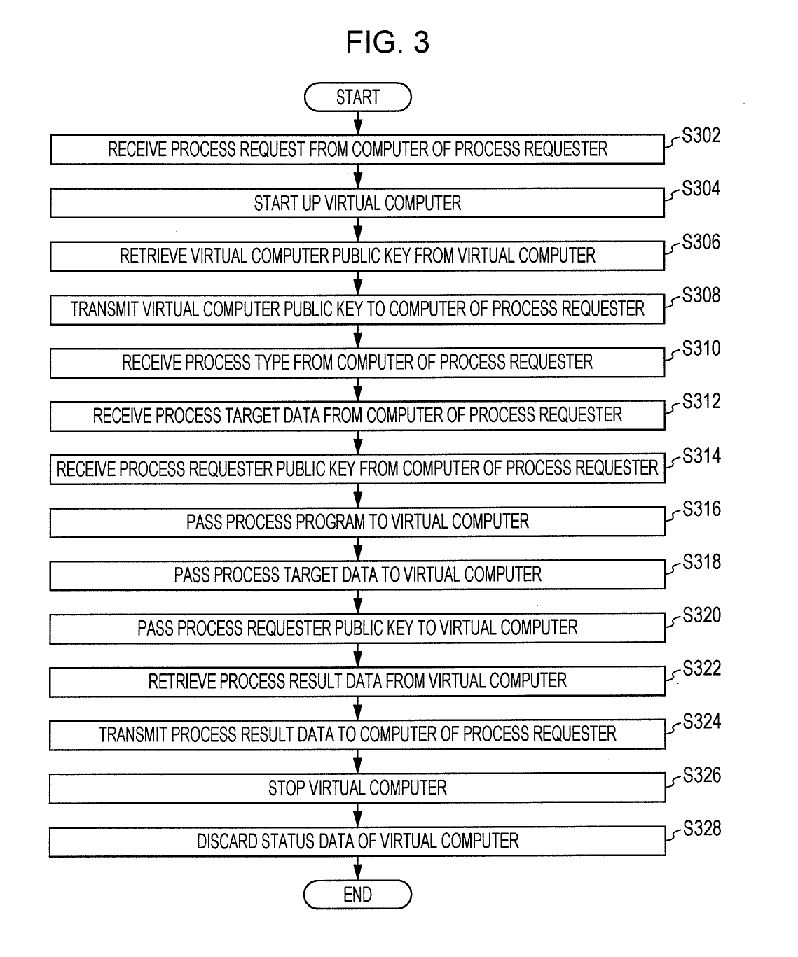

FIG. 3 is a flowchart illustrating a process example of the exemplary embodiment. The operation procedure of the computer 112 performed in response to a single process request in the proxy operation is described below. The proxy operation is performed in one form of service. The computer 112 waits on standby until one process request, and executes the process of FIG. 3 in response to the process request. Multiple process requests may be honored in service. The same process may be repeated in response to the multiple process requests. Optionally, processes may be performed in response to different process requests. In the process example, herein, the process program retrieving module 106 may receive at least one process program in advance from the computer 170, and the process program may be stored in association with a process type on a storage module (not illustrated) within the computer 112 performing the proxy operation.

In the standby state, the computer 112 has retrieved the process program but has not received the process request.

In step S302, the process target data retrieving module 102 receives the process request from the computer 160 of the process requester.

When the process request is received, the virtual computer control module 108 starts up the virtual computer module 110 in step S304. In other words, the virtual computer control module 108 generates the virtual computer module 110. The virtual computer module 110 is in an initial state (having neither the process program nor the process target data).

In step S306, the virtual computer control module 108 retrieves the virtual computer public key from the virtual computer module 110. As described above, the virtual computer public key is the one generated by the virtual computer key pair generating module 202 and output by the virtual computer public key output module 204.

In step S308, the process target data retrieving module 102 transmits the virtual computer public key to the computer 160 of the process requester.

In step S310, the process target data retrieving module 102 receives a process type from the computer 160. The process type is an index representing a process to be performed on the process target data. The process program is determined in accordance with the process type.

In step S312, the process target data retrieving module 102 receives the process target data from the computer 160 of the process requester.

In step S314, the process target data retrieving module 102 receives the process requester public key from the computer 160 of the process requester.

The order of step S310 through step S314 is not limited to the order described above, and any one step may be performed earlier than another.

In step S316, the virtual computer control module 108 pass to the virtual computer module 110 the process program corresponding to the process type.

In step S318, the virtual computer control module 108 passes the process target data to the virtual computer module 110.

In step S320, the virtual computer control module 108 passes the process requester public key to the virtual computer module 110.

The order of steps S316 through S320 is not limited to the order described above, and any one step may be performed earlier than another.

The following process may be performed after the completion of the process of the virtual computer module 110.

In step S322, the virtual computer control module 108 retrieves the process result data from the virtual computer module 110.

In step S324, the process result data transmitting module 104 transmits the process result data to the computer 160 of the process requester.

In step S326, the virtual computer control module 108 stops the operation of the virtual computer module 110.

In step S328, the virtual computer control module 108 discards (more specifically, deletes) the status data of the virtual computer module 110. The status data are data used by the virtual computer module 110 in the present process, and data other than the process result data output by the virtual computer module 110 in step S322. If the process result data are transmitted in step S324, the status data deleted may include the process result data.

The process target data retrieving module 102 retrieves from the computer 160 used by the process requester (process requester computer) the process target data encrypted with the virtual computer public key and the process requester public key.

The process program retrieving module 106 retrieves the process program from the computer 170.

The process result data transmitting module 104 transmits to the computer 160 (the process requester computer) the process requester public key output by the virtual computer public key output module 204 in the virtual computer module 110 and the process result data encrypted with the process requester public key and output by the encrypted process result data output module 216 in the virtual computer module 110. The data exchanging with the virtual computer module 110 is performed via the virtual computer control module 108.

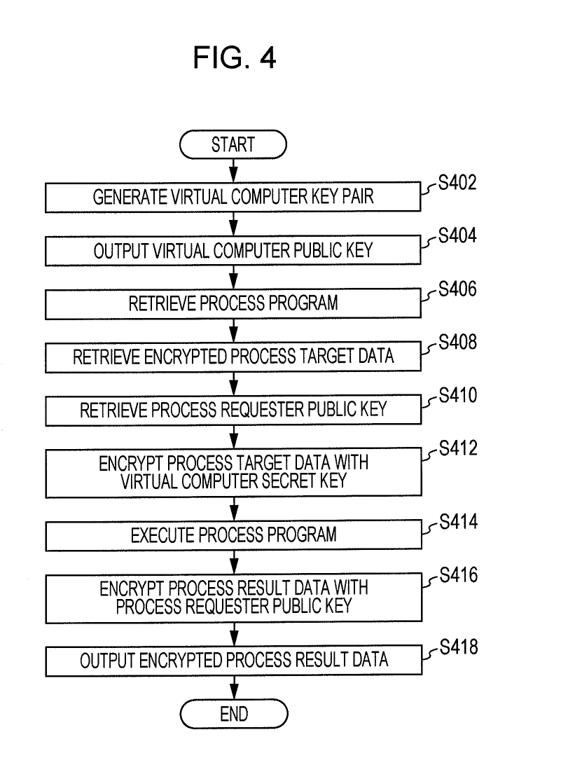

FIG. 4 is a flowchart illustrating a process of the exemplary embodiment. A process example that the virtual computer module 110 performs in response to a single process request is described below. The process example is performed by the virtual computer module 110 after being started up by the virtual computer control module 108.

In step S402, the virtual computer key pair generating module 202 generates a key pair for use in asymmetric cryptography.

In step S404, the virtual computer public key output module 204 outputs to the virtual computer control module 108 one of the key pair as the virtual computer public key. The other of the key pair is retained as a virtual computer secret key to the secret storage module within the virtual computer module 110.

In step S406, the process program retrieving module 210 retrieves the process program from the virtual computer control module 108.

In step S408, the encrypted process target data retrieving module 206 retrieves the encrypted process target data from the virtual computer control module 108.

In step S410, the process requester public key retrieving module 218 retrieves the process requester public key from the virtual computer control module 108.

The order of steps S406 through S410 is not limited to the order described above, and any one step may be performed earlier than another.

In step S412, the process target data decryption module 208 decrypts the process target data with the virtual computer secret key.

In step S414, the process program executing module 212 executes the process program on the decrypted process target data.

In step S416, the process result data encryption module 214 encrypts the process target data obtained as a process result with the process requester public key retrieved in step S410.

In step S418, the encrypted process result data output module 216 outputs the encrypted process result data to the virtual computer control module 108.

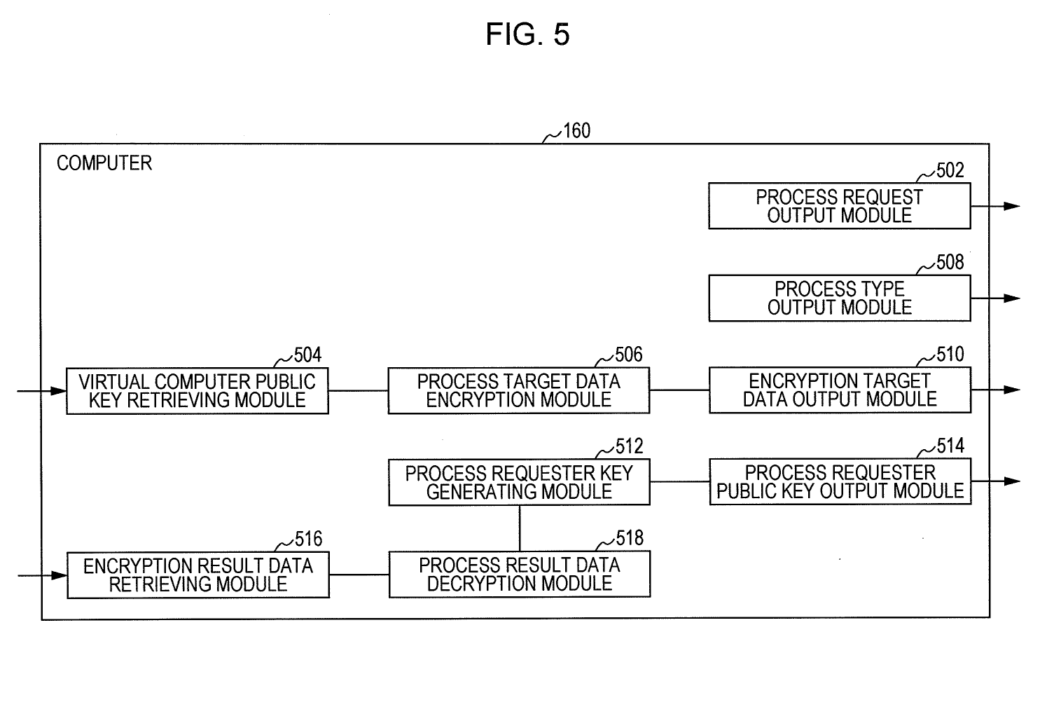

FIG. 5 illustrates a module configuration of the computer 160 of the process requester.

The computer 160 includes process request output module 502, virtual computer public key retrieving module 504, process target data encryption module 506, process type output module 508, encryption target data output module 510, process requester key generating module 512, process requester public key output module 514, encryption result data retrieving module 516, and process result data decryption module 518. These modules are implemented as programs to be executed on the computer 160.

The process request output module 502 outputs a process request to the computer 112.

The process type output module 508 outputs a process type to the computer 112.

The virtual computer public key retrieving module 504 is connected to the process target data encryption module 506. The virtual computer public key retrieving module 504 retrieves the virtual computer public key from the computer 112.

The process target data encryption module 506 is connected to the virtual computer public key retrieving module 504 and the encryption target data output module 510. The process target data encryption module 506 encrypts the process target data with the virtual computer public key retrieved by the virtual computer public key retrieving module 504.

The encryption target data output module 510 is connected to the process target data encryption module 506. The encryption target data output module 510 outputs to the computer 112 the process target data encrypted by the process target data encryption module 506.

The process requester key generating module 512 is connected to the process requester public key output module 514 and the process result data decryption module 518. The process requester key generating module 512 generates the key pair of asymmetric cryptography including a process requester secret key used only within the computer 160 and a process requester public key corresponding to the process requester secret key.

The process requester public key output module 514 is connected to the process requester key generating module 512. The process requester public key output module 514 outputs the process requester public key of the key pair generated by the process requester key generating module 512 to the computer 112. The process requester secret key is retained in a secret key storage module (not illustrated) within the computer 160.

The encryption result data retrieving module 516 is connected to the process result data decryption module 518. The encryption result data retrieving module 516 receives the process result data from the computer 112.

The process result data decryption module 518 is connected to the process requester key generating module 512 and the encryption result data retrieving module 516. The process result data decryption module 518 decrypts the process result data retrieved by the encryption result data retrieving module 516 with the process requester secret key within the secret key storage module of the computer 160.

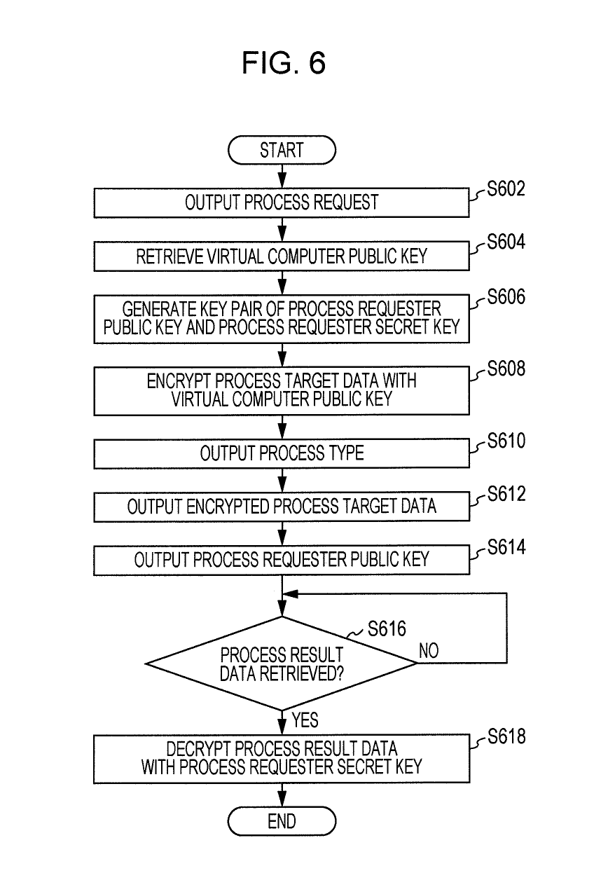

FIG. 6 is a flowchart illustrating a process example of the exemplary embodiment. The process example is performed by the computer 160.

In step S602, the process request output module 502 outputs the process request to the computer 112.

In step S604, the virtual computer public key retrieving module 504 retrieves the virtual computer public key from the computer 112.

In step S606, the process requester key generating module 512 generates the key pair of the process requester public key and the process requester secret key.

In step S608, the process target data encryption module 506 encrypts the process target data with the virtual computer public key.

In step S610, the process type output module 508 outputs the process type to the computer 112.

In step S612, the encryption target data output module 510 outputs the encrypted process target data to the computer 112.

In step S614, the process requester public key output module 514 outputs the process requester public key to the computer 112.

The order of steps S610 through S614 is not limited to the order described above, and any one step may be performed earlier than another.

It is determined in step S616 whether the encryption result data retrieving module 516 has received the process result data from the computer 112. If the process result data has been retrieved, processing proceeds to step S618; otherwise (in the standby state until the process result data is retrieved), step S616 is repeated.

In step S618, the process result data decryption module 518 decrypts the process result data with the process requester secret key.

The program of the process of FIG. 6 may be produced in advance and the computer 112 may supply the computer 160 with the program.

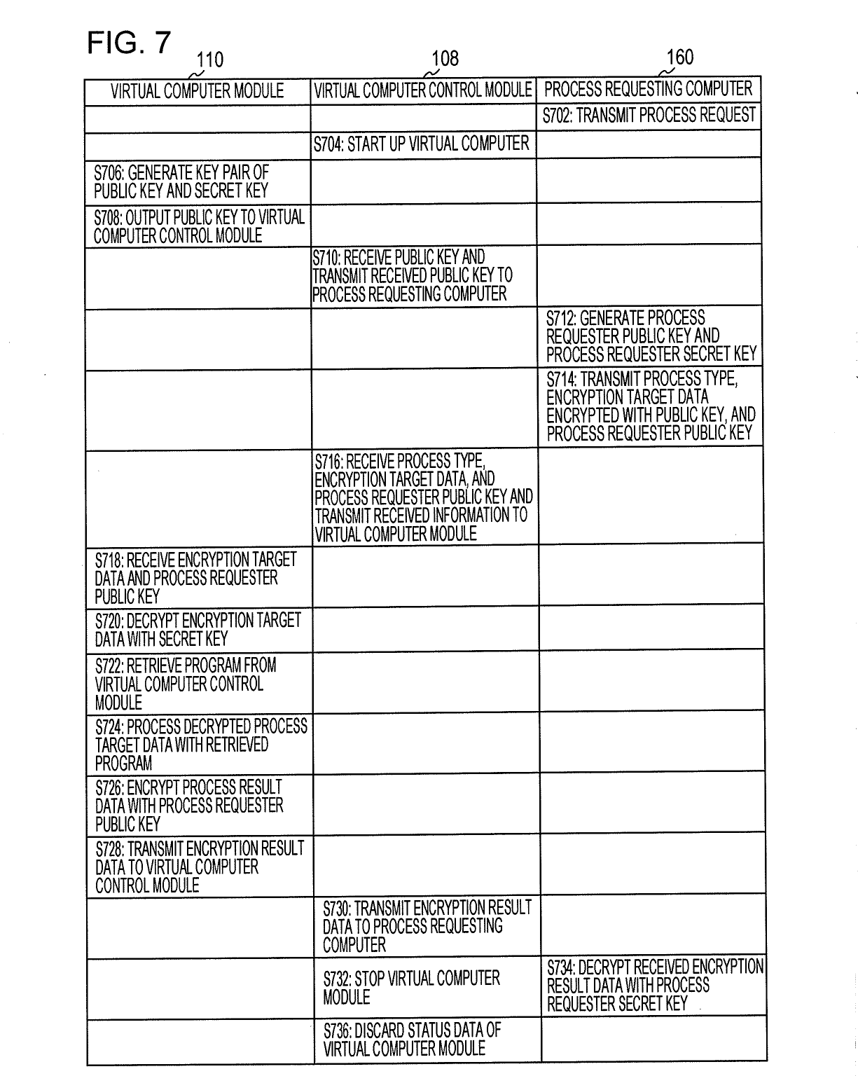

FIG. 7 is a flowchart illustrating a process example of the exemplary embodiment. The process example is performed using the virtual computer module 110, the virtual computer control module 108, and the computer 160.

In step S702, the computer 160 transmits the process request to the computer 112.

In step S704, the virtual computer control module 108 starts up the virtual computer module 110.

In step S706, the virtual computer module 110 generates the key pair of the virtual computer public key and the virtual computer secret key.

In step S708, the virtual computer module 110 outputs the virtual computer public key to the virtual computer control module 108.

In step S710, the virtual computer control module 108 receives the virtual computer public key from the virtual computer module 110 and then transmits the virtual-computer public key to the computer 160.

In step S712, the computer 160 generates the process requester public key and the process requester secret key.

In step S714, the computer 160 transmits to the computer 112 the process type, the encryption target data encrypted with the virtual computer public key, and the process requester public key.

In step S716, the virtual computer control module 108 receives the process type, the encryption target data, and the process requester public key from the computer 160 via the process target data retrieving module 102. The virtual computer control module 108 then transmits the encryption target data and the process requester public key to the virtual computer module 110.

In step S718, the virtual computer module 110 receives the encryption target data and the process requester public key.

In step S720, the virtual computer module 110 decrypts the encryption target data with the virtual computer secret key.

In step S722, the virtual computer module 110 retrieves the process program from the virtual computer control module 108.

In step S724, the virtual computer module 110 processes the decrypted process target data using the retrieved process program.

In step S726, the virtual computer module 110 encrypts the process result data with the process requester public key.

In step S728, the virtual computer module 110 transmits the encryption result data to the virtual computer control module 108.

In step S730, the virtual computer control module 108 transmits the encryption result data to the computer 160 via the process result data transmitting module 104.

In step S732, the virtual computer control module 108 ends the virtual computer module 110.

In step S734, the computer 160 decrypts the received encryption result data with the process requester secret key.

In step S736, the virtual computer control module 108 discards the status data of the virtual computer module 110.

The process target data transmitted from the process requester is encrypted with the virtual computer public key and the virtual computer secret key for decryption is retained in the virtual computer module 110. The decryption of the process target data outside the virtual computer module 110 is thus difficult. The process target data remains encrypted with the process requester public key within the virtual computer module 110, and the process target data may be decrypted with only the process requester secret key held by the process requester. The virtual computer module 110 is designed such that only the encrypted process target data, the process program, and the process requester public key are received thereinto, and such that the virtual computer public key and the encrypted process result data are output therefrom. Even if the operation related to the security of the process program supplied by the computer 170 remains unreliable, information related to the process target data is prevented from being exposed outside the virtual computer module 110 in an unprotected state. After the completion of the process of the virtual computer module 110, the virtual computer control module 108 discards the status data related to the internal state of the virtual computer module 110. The information related to the process target data is used no longer.

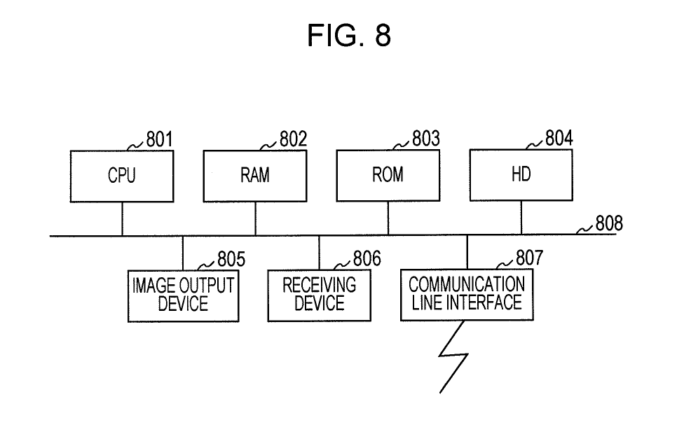

The computers (the computer 112, the computer 160, and the computer 170) of the exemplary embodiment executing the programs have a hardware configuration of a typical computer as illustrated in FIG. 8. More specifically, the computer is a personal computer or a computer serving as a server. More specifically, the computer includes a central processing unit (CPU) 801 as a processor, and random-access memory (RAM) 802, read-only memory (ROM) 803, and hard disc (HD) 804 as storage devices. The CPU 801 executes the programs. The programs to be executed by the CPU 801 include the process target data retrieving module 102, the process result data transmitting module 104, the process program retrieving module 106, the virtual computer control module 108, the virtual computer module 110, the virtual computer key pair generating module 202, the virtual computer public key output module 204, the encrypted process target data retrieving module 206, the process target data decryption module 208, the process program retrieving module 210, the process program executing module 212, the process result data encryption module 214, the encrypted process result data output module 216, the process requester public key retrieving module 218, the process request output module 502, the virtual computer public key retrieving module 504, the process target data encryption module 506, the process type output module 508, the encryption target data output module 510, the process requester key generating module 512, the process requester public key output module 514, the encryption result data retrieving module 516, and the process result data decryption module 518. The computer further includes the RAM 802 storing the data and the programs, the ROM 803 storing a program starting the computer, and the HD 804 as an auxiliary memory device. The computer further includes a receiving device 806 receiving data in response to an operation performed on a keyboard, a mouse, or a touchpanel by a user, an image output device 805 such as a cathode ray tube (CRT) or a liquid-crystal display (LCD), a communication line interface 807 such as a network interface card for connection with a communication network, and a bus 808 interconnecting these elements for data exchange. Multiple computers may be connected via a network.

The software computer program as the exemplary embodiment may be read onto a hardware structure system and then executed with the hardware structure system in cooperation with software resources. The hardware configuration of FIG. 8 is illustrated for example purposes only. The exemplary embodiment is not limited to the configuration of FIG. 8. Any structure is acceptable as long as the structure implements the modules described with reference to the exemplary embodiment. For example, one of the modules may be constructed of a particular hardware structure (such as application specific integrated circuit (ASIC)). One of the modules may belong to an external system and may be connected to the system of the exemplary embodiment via a communication line. Multiple systems, each illustrated in FIG. 8, may be interconnected via a communication line such that the systems operate in concert with each other. The system may be incorporated in each of the personal computer, digital home appliance, photocopier, facsimile machine, scanner, printer, complex machine (serving at least two of the scanner, the printer, the photocopier, and the facsimile machine).

The process of each module may include a technique described as the related art technique.

The above-described program may be supplied in a stored state on a recording medium. The program may also be provided via a communication network. In such a case, the above-described program may be understood as an invention of a “computer readable recording medium storing the program.”

The “computer readable recording medium storing the program” refers to a computer readable recording medium storing the program, and used to install the program, to execute the program, or to distribute the program.

The recording media include digital versatile disc (DVD), compact disc (CD), Blu-ray disc (registered trademark), magnetooptical disc (MO), flexible disc (FD), magnetic tape, hard disc, read-only memory (ROM), electronically erasable and programmable read-only memory (EEPROM (registered trademark)), flash memory, and random-access memory (RAM). The DVDs include “DVD-R, DVD-RW, and DVD-RAM” complying with the standard formulated by the DVD forum, and “DVD+R and DVD+RW” complying with DVD+RW standards. The CDs include read-only CD (CD-ROM), recordable CD-R, and rewritable CD-RW.

The program in whole or in part may be stored on the recording medium for storage and distribution. The program in whole or in part may be transmitted via a transfer medium. The transfer media include a wired network, a wireless network, or a combination thereof. The wired networks include a local-area network (LAN), a metropolitan-area network (MAN), a wide-area network (WAN), the Internet, an intranet, and an extranet. The program in whole or in part may be transmitted over a carrier wave.

The program may be part of another program, or may be stored on the recording medium together with another program. The program may be split and split programs may then be stored on the recording medium. The program may be processed in any fashion before being stored as long as the program remains restorable. For example, the program may be compressed or encrypted before storage.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus including a virtual computer, the virtual computer comprising:
a key pair generating unit that generates a key pair of asymmetric cryptography including a virtual computer secret key used in only the virtual computer of the image processing apparatus and a virtual computer public key corresponding to the virtual computer secret key;
a public key output unit that outputs the virtual computer public key of the key pair generated by the key pair generating unit;
a process target data retrieving unit that retrieves, from outside the virtual computer, process target data encrypted with the virtual computer public key;
a decryption unit that decrypts the process target data encrypted with the virtual computer public key and retrieved by the process target data retrieving unit;
a process program retrieving unit that retrieves a process program from outside the virtual computer;
an executing unit that executes the process program retrieved by the process program retrieving unit on the process target data decrypted by the decryption unit;
a public key retrieving unit that retrieves a process requester public key from outside the virtual computer;
an encryption unit that encrypts, with the process requester public key retrieved by the public key retrieving unit, process result data provided by the executing unit as a process result of the process program; and
a process result data output unit that outputs, to outside the virtual computer, the process result data encrypted by the encryption unit.

2. The image processing apparatus according to claim 1, wherein the process target data retrieving unit retrieves, from a process requester computer used by a process requester, the process requester public key and the process target data encrypted with the virtual computer public key;
wherein the process program retrieving unit retrieves the process program from a process program supplying unit;
wherein the image processing apparatus further comprises:
a process result data transmitting unit that transmits, to the process requester computer, the virtual computer public key output by the public key output unit in the virtual computer and the process result data that are encrypted with the process requester public key and output by the process result data output unit in the virtual computer; and
a virtual computer control unit that controls a startup and a deletion of the virtual computer, and at the deletion of the virtual computer, a deletion of data used by the virtual computer.

3. An information processing method of an information processing apparatus including a virtual computer, the method comprising:
generating, with a microprocessor, a key pair of asymmetric cryptography including a virtual computer secret key used in only the virtual computer and a virtual computer public key corresponding to the virtual computer secret key;
outputting the virtual computer public key of the generated key pair;
retrieving, from outside the virtual computer, process target data encrypted with the virtual computer public key;
decrypting the retrieved process target data encrypted with the virtual computer public key;
retrieving a process program from outside the virtual computer;
executing the retrieved process program on the decrypted process target data;
retrieving a process requester public key from outside the virtual computer;
encrypting, with the retrieved process requester public key, process result data provided as a process result of the process program; and
outputting, to outside the virtual computer, the encrypted process result data.

4. A non-transitory computer readable medium storing a program causing a computer to execute a process for performing as an information processing apparatus including a virtual computer, the process comprising:
generating a key pair of asymmetric cryptography including a virtual computer secret key used in only the virtual computer and a virtual computer public key corresponding to the virtual computer secret key;
outputting the virtual computer public key of the generated key pair;
retrieving, from outside the virtual computer, process target data encrypted with the virtual computer public key;
decrypting the retrieved process target data encrypted with the virtual computer public key;
retrieving a process program from outside the virtual computer;
executing the retrieved process program on the decrypted process target data;
retrieving a process requester public key from outside the virtual computer;
encrypting, with the retrieved process requester public key, process result data provided as a process result of the process program; and
outputting, to outside the virtual computer, the encrypted process result data.
